(19) United States
(12) Patent Application Publication
(10) Pub. No.: US 2001/0025412 A1
(43) Pub. Date: Oct. 4, 2001

(54) Contact processing station

(76) Inventor: Markus Burger, Steinhausen (CH)

Correspondence Address: McCormick, Paulding & Huber, City Place II, 185 Asylum Street, Hartford, CT, 06103-3402, US

(21) Appl. No.: 09/826,156

(22) Filed: Apr. 4, 2001

(30) Foreign Application Priority Data
Apr. 4, 2000 (EP) 00810295.6

(51) Int. Cl. B23P 19/00; H01R 43/00; B23Q 15/00

(52) U.S. Cl. 29/748; 29/747; 29/761; 29/707

(57) ABSTRACT

A contact processing station with a mechanical press for the securing of a contact to a cable has a first cheek plate and a second cheek plate controlled by a drive. The first or second cheek plate is spring mounted. An elastically deformable element, for example a connecting rod capable of deformation or a spring, is available for the spring mounting. During the crimping process, the elastically deformable element is increasingly deformed until the force acting on the contact has reached a maximum whereby the force acting on the contact increases continuously with increasing deformation of the elastically deformable element. The spring constant of the elastic element is set so soft that the force with which the contact is compressed onto the cable is almost independent of fluctuations in the wire thickness.

### BACKGROUND OF THE INVENTION

The invention concerns a contact processing station for crimping a contact onto a wire.

Such contact processing stations are used in order to secure an electrical contact, for example a connector, to a cable by means of compression. In doing so, the contact undergoes plastic deformation so that it surrounds the stripped cable end with a secure press fit. This process is called crimping. Such a contact processing station can also be used in order to secure a sealing ring, known in technical jargon as a seal, to the cable. The contact and the sealing ring can be secured to the cable in one contact processing station or in two contact processing stations.

Such contact processing stations are manufactured and sold by the applicant as well as by other companies. With these contact processing stations, the contacts are crimped at a predetermined crimp height with a press developed as rigidly as possible. The force acting on the contact during the crimping process which compresses it onto the wire is much dependent on the diameter of the stripped end of the cable. Deviations in the wire diameter occur naturally because the wire is generally formed from many leads and because it can also happen that during stripping, one or the other lead is cut off and lost. The thickness of the leads can also vary. If the end of the wire is thinner than intended, then, with a contact processing station customary on the market formed with a rigid press which compresses at a given crimp height, the crimp force is reduced because of a lack of crimp resistance and therefore the quality of the compression is diminished. For this reason, the force occurring during crimping is measured, usually with piezoelectric sensors. The crimped contact is rejected as being faulty if the force measured is not within given limit values. It is even usual to register the force trend during the crimping process and to reject the contact as being faulty when the force trend is not within a given tolerance range.

A contact processing station of this type is described, for example, in the European patent application EP 884811.

The object of the invention is to reduce the rejection rate of this type of contact processing station and to increase the process security.

The named task is solved in accordance with the invention by means of the features of claim 1. Advantageous designs result from the dependent claims.

### BRIEF DESCRIPTION OF THE INVENTION

The invention is based on the idea that the press of the contact processing station has an elastically deformable element, ie an element capable of elastic deformation, which, during the crimping process, undergoes controlled deformation depending on the force which occurs. The elastically deformable element is increasingly deformed during the crimping process until the force acting on the contact reaches a maximum whereby the force acting on the contact increases continuously with increasing deformation of the elastically deformable element. The spring constant of the elastic element is set so soft that the force with which the contact is compressed onto the end of the wire is almost independent of deviations in the wire thickness. In this way, a gas-tight crimp is achieved even with wire ends which deviate too strongly from the set value for processing with a conventional press and would therefore have to be rejected as scrap.

The contact processing station in accordance with the invention with an elastically deformable element is distinguished in that, with a deviation in the effective crimp height of, for example, 0.2 mm from the optimum set crimp height, the maximum crimp force only changes minimally while the crimp force of a rigid contact processing station known from prior art increases or decreases by at least a factor of 2.

In the following, embodiments of the invention are explained in more detail based on the drawing.

### BRIEF DESCRIPTION OF THE DRAWING FIGURES

It is shown in: FIGS. 1-3 a contact processing station at three different moments during a crimping process,

FIGS. 4A-F various connecting rods,

FIG. 5 geometrical details of the contact processing station,

FIG. 6 a further contact processing station,

FIG. 7 a contact processing station with a measuring system for determining the force exerted on the contact to be crimped,

FIG. 8 a contact processing station with a knuckle-joint press, and

FIG. 9 a contact processing station with a linear press.

### DETAILED DESCRIPTION OF THE INVENTION

FIGS. 1-3 show a schematic presentation of the parts of a contact processing station necessary for understanding the invention at three different moments during a crimping process. The contact processing station comprises a mechanical press which has a first cheek plate 1 and a second cheek plate 2 controlled by a drive. The first cheek plate 1, which is usually also termed as bottom die or anvil, is rigidly arranged on a base plate 3. The second cheek plate 2, which is usually also termed as die or crimper, is led in vertical direction by means of a guide element 4. The drive, in the form of an eccentric, comprises an eccentric disc 5, which is turned by a not presented motor on its horizontally running rotational axis 6 with alternating direction of rotation back and forth between two upper turning points 7 and 8 which drives a connecting rod 9. The connecting rod 9 bears on the outer edge of the eccentric disc 5 and on the second cheek plate 2 with joints 10 and 11. The connecting rod 9 transforms the turning movement of the eccentric disc 5 into a longitudinal movement of the second cheek plate 2. As work piece, a contact 12 pushed onto a stripped wire end is located on the first cheek plate 1. The lead is held in this position by not presented means. With this first embodiment, the connecting rod 9 is formed as an elastically deformable element. As a result of this, the second cheek plate 2 is therefore spring-mounted.

FIG. 1 shows the press at the start of the crimping process in a condition A in which the distance between the two cheek plates 1 and 2 is at a maximum. The connecting rod 9 is without load and therefore not deformed. The distance between the two joints 10 and 11 can be considered as the length L₀ of the connecting rod 9 without load. FIG. 2 shows the press in a condition B with which the second cheek plate 2 has just touched the contact 12 with which however the two cheek plates 1 and 2 do not yet exert any significant force on the contact 12. The connecting rod 9 is therefore still not deformed. FIG. 3 shows the press in a condition C with which the joint 10 runs through the bottom dead center 13 at which the upper end of the connecting rod 9 occupies the lowest point during the crimping process. During the transition of the press from condition B to condition C, a force F is increasingly built up between the contact 12 and the second cheek plate 2 which reaches its maximum Fₘₐₓ condition C. On the one hand, the force F leads to the compression of the contact 12 onto the bare end of the wire and, on the other hand, leads to an elastic deformation of the connecting rod 9, whereby the deformation of the connecting rod 9 is largest in condition C of the press. In FIG. 3 the deformation of the connecting rod 9 is presented as a bending of the connecting rod 9. With the deformation of the connecting rod 9, the distance between the two joints 10 and 11 is shortened: This shortening ΔL can be used as a measure for the deformation of the connecting rod 9. If the eccentric disc 5 is now turned further beyond the bottom dead center 13, then the force F reduces again and the connecting rod 9 stretches again until the distance between the two joints 10 and 11 again achieves its original length L₀. As soon as the eccentric disc 5 reaches the upper turning point 8, the direction of rotation is changed and the next crimping process is carried out with the next work piece.

The second cheek plate 2 is detachably mounted on the connecting rod 9. With many contact processing stations usual on the market, the press is dimensioned in such a way that, when the eccentric disc 5 runs through the bottom dead center 13 with the cheek plate 2 removed, the distance between the base plate 3 and the lower end of the connecting rod 9 amounts to exactly 135.78 mm.

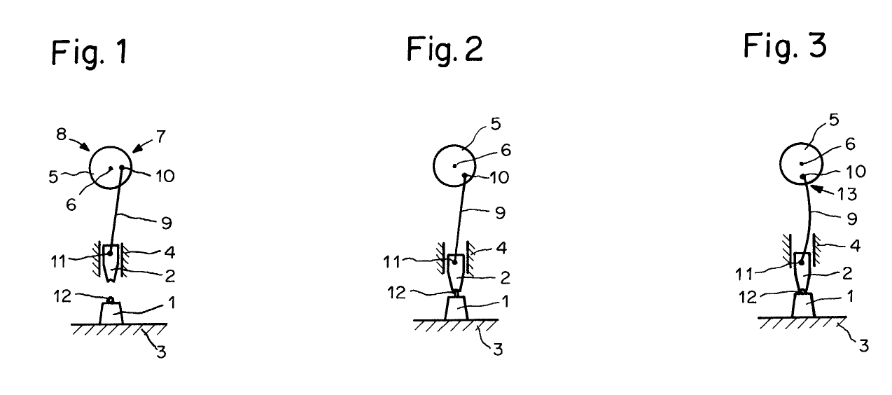

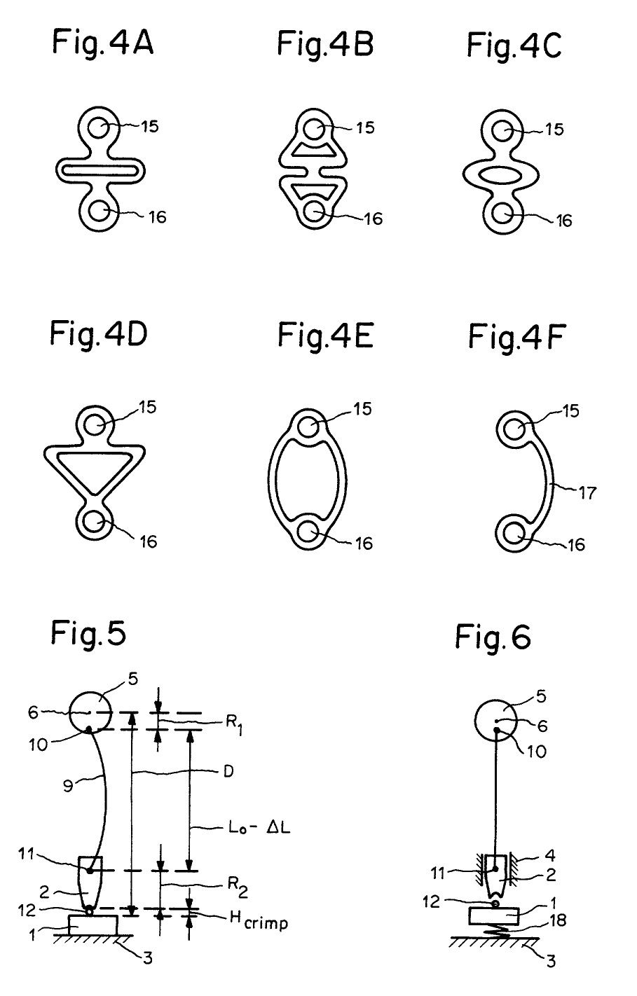

FIGS. 4A-F show as an example numerous possible designs of the connecting rod 9. Such a connecting rod 9 is preferably manufactured from one piece, can however comprise also several parts and classical springs. The connecting rod 9 has one circular opening 15 and 16 at each of its lower and upper ends into which a bolt secured to the second cheek plate 2 (FIG. 1) and a bolt secured to the eccentric disc 5 engage. The opening 15 and the bolt assigned to it form the first joint 10 (FIG. 1), opening 16 and the bolt assigned to it form the second joint 11. The connecting rods 9 presented in FIGS. 4A-E are formed as symmetrically constructed springs which are compressed by the force F acting on them during the crimping process. The connecting rod 9 presented in FIG. 4F is formed as an asymmetrical element with a curved stay 17 connecting the joints, the bending of which increases under the force F acting on it during the crimping process.

From FIG. 5 it can be deduced that the maximum deformation ΔLₘₐₓ of the connecting rod 9 is given by the equation

ΔLₘₐₓ=R₁+R₂+L₀+H_{crimp}−D (1)

whereby R₁ denotes the distance of the center of motion of the first joint 10 from the rotational axis 6 of the eccentric disc 5, R₂ the distance of the center of motion of the second joint 11 from the press surface of the second cheek plate 2, L₀ the length of the connecting rod 9, ie, the distance between the two joints 10 and 11 in the condition of the connecting rod 9 without load, and H_{crimp} the height of the compressed contact 12, the so-called crimp height. The maximum force, the so-called crimp force F_{crimp}, which acts on the contact 12 in the condition C of the press, results from the characteristic curve F(ΔL) of the connecting rod 9 between the force F and the length change ΔL. If the characteristic curve is linear:

F=K*ΔL (2)

whereby the variable K designates the spring constant of the connecting rod 9, one gets

F_{crimp}=K*(R₁+R₂+L₀+H_{crimp}−D) (3)

Hence, if during production of the crimp connections the crimp height H_{crimp} of the compressed contact 12 varies between the values H_{crimp, min} and H_{crimp, max}, for example because of a different number of leads at the end of the wire, then the maximum force effective during the crimping process fluctuates between the values F_{crimp, min} and F_{crimp, max}, which can be calculated with the equation (3).

It is entirely possible to develop the connecting rod 9 in such a way that the ratio between the force F and the length change ΔL is non-linear in contrast to equation (2).

From equation (3) it can be seen that the strength of the force F is dependent on the distance D between the press surface of the first cheek plate 1 (FIG. 1) on which the contact 12 rests during the crimping process and the rotational axis 6 of the eccentric disc 5. Therefore, the contact processing station is preferably developed so that this distance D is changeable: The rotational axis 6 of the eccentric disc 5 can, for example, be a shaft arranged on the casing of a cylinder which can be rotated on its longitudinal axis arranged rigidly in relation to the base plate 3. The cylinder can be rotated on its longitudinal axis by hand but preferably by means of a program-controlled motor. In this way, the force F_{H,crimp} assigned to a predetermined crimp height H_{crimp} can be altered within certain limits.

The spring constant K amounts to, for example, 5000 N/mm. With a typical deformation of the connecting rod 9 of length ΔL=2 mm, the crimp force F_{crimp}, which acts on the contact 12 results in F=10,000 N. However, if the deformation of the connecting rod 9 only amounts to 1.8 mm, then the crimp force F_{crimp} still amounts to 9,000 N, ie, only 10 percent less. With a conventional contact processing station, on the other hand, the crimp force F_{crimp} would be reduced by at least 50%.

With the contact processing station in accordance with the invention, the crimping process is more robust: Fluctuations in the environmental temperature may however cause variations in the distance D. Nevertheless, consistently good crimp connections are achieved as the crimp force F_{crimp} only varies insignificantly.

FIG. 6 shows an embodiment with which the connecting rod 9 is not deformed but with which the first cheek plate 1 bears on the base plate 3 by means of a spring 18. In this case, the fixing arrangement for the wire is preferably secured to the cheek plate 1 so that the contact 12 and the wire do not shift in relation to the fixing arrangement on spring deflection of the cheek plate 1 during the crimping process.

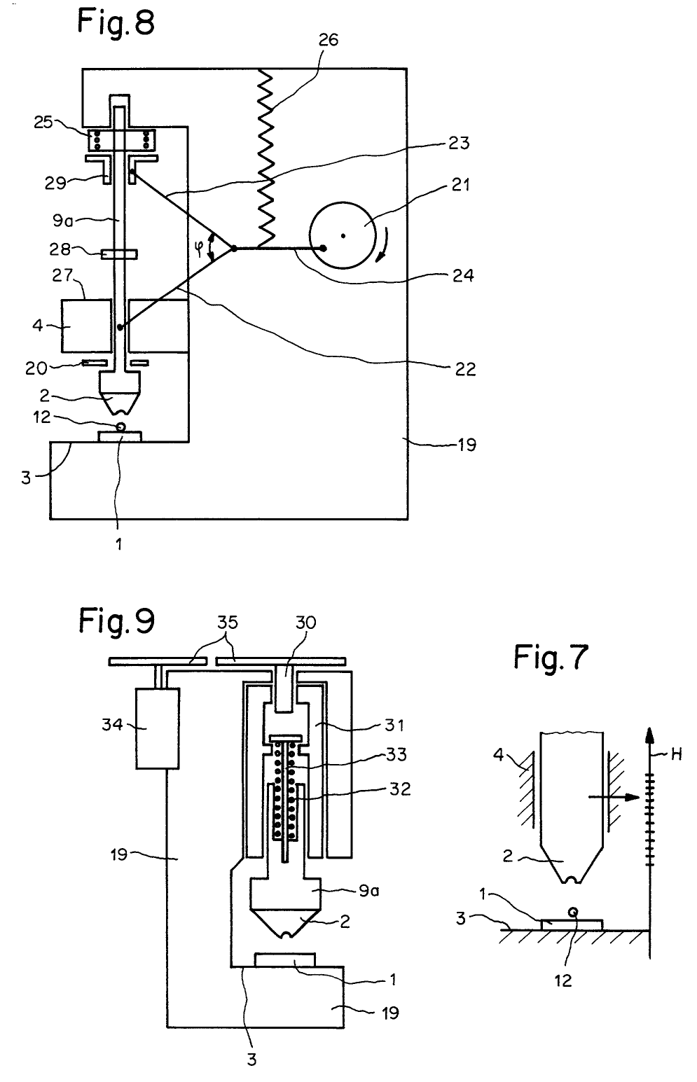

FIG. 7 shows the first embodiment with a measuring system for measuring the crimp force F_{crimp}, acting on the contact 12 during the crimping process, that is the force which acts on the contact 12 when the joint 10 (FIG. 3) passes the bottom dead center 13. Measurement of the crimp force F_{crimp} takes place by means of measuring the maximum deformation ΔLₘₐₓ of the connecting rod 9 and calculating the crimp force based on the known characteristic curve F_{crimp}=F(ΔLₘₐₓ) or a characteristic curve determined by means of a calibration procedure.

Any commercial measuring system can be used as the measuring system. From the equation (1) it can be seen that equivalently the crimp height H_{crimp} can be measured instead of the deformation ΔL of the connecting rod 9. Therefore, during the crimping process, it is preferable to determine the height H₁(t) of the second cheek plate 2 in relation to the static guide element 4 as a function of time t, to save it and then determine its minimum H_{1,min}. The height H_{1,min} and the crimp height H_{crimp} are linked by the equation H_{1,min}=H_{crimp}+H₀ whereby the variable H₀ represents a constant to be determined by means of a calibration.

The crimp force F_{crimp} then results from the equation (3) as

F_{crimp}=K*(R₁+R₂+L₀+H_{1,min}−H₀−D) (4)

The contact processing station is, as already mentioned, preferably developed so that the distance D can be adjusted by hand or by a motor. A second measuring system is therefore foreseen so that, after a change, the distance D can be determined automatically.

The invention is not limited to a particular type of press. Apart from eccentric presses, other mechanical presses, for example knuckle-joint presses or linear presses, can also be used. With a knuckle-joint press for example, one of the two knuckle joints or both knuckle joints are developed as elements capable of elastic deformation.

Based on FIGS. 8 and 9, two embodiments are explained with which a spring as the bearing for the cheek plate 2 is foreseen as the elastically deformable element. This spring is compressed during the crimping process.

FIG. 8 shows a contact processing station with a knuckle-joint press. The contact processing station comprises a basic frame 19 into which the first cheek plate 1 is integrated, a body 20 adjustable in height above the first cheek plate 1, a rod 9a to which the second cheek plate 2 is secured, an eccentric drive 21, two knuckle joints 22 and 23, a rod 24 which connects the two knuckle joints 22, 23 and the eccentric drive 21, a first spring 25 and a second spring 26. The guide element 4 for vertical guidance of the rod 9a is secured to the basic frame 19. The body 20 serves as a stop for the rod 9a or the second cheek plate 2. The basic frame 19 has a stop face 27 which combines with a bush 28 mounted rigidly on the rod 9a to limit the downward movement of the rod 9a in order to prevent the second cheek plate 2 from hitting the first cheek plate 1 with full impact and possibly damaging it. A second, sliding bush 29 is mounted on the rod 9a. One end of the first knuckle joint 22 bears on rod 9a, the other end bears on rod 24. One end of the second knuckle joint 23 bears on the second bush 29, the other end bears on rod 24. The spring 26 pulls the rod 24 upwards in vertical direction. In this way, in the idle condition, the cheek plate 2 rigidly connected to rod 9a is pulled upwards until it comes to stop on the body 20. The spring 25 is arranged between the basic frame 19 and the bush 29 as an elastically deformable element. In order to adjust the set crimp force, the spring 25 secured to the basic frame 19 can be slid in vertical direction by not presented manual or motorised means. In addition, the spring 25 can be pre-tensioned with a not presented adjusting screw, for example, to a force F_{V} of 1000 N. The height of the body 20 above the first cheek plate 1 is adjustable so that the stroke carried out by the second cheek plate 2 is adjustable. Common values for the stroke are 30 mm or 40 mm.

During operation, the eccentric disc 21 continuously rotates on its rotational axis 6. In doing so, the knuckle-joint press goes through the following phases:

1. The eccentric drive 21 first approaches its right-hand dead center position. In doing so, the rod 24 is pulled to the right. As a result of this, the angle φ between the two knuckle joints 22, 23 reduces. Because of the spring 26, the rod 24 and therefore also the two knuckle joints 22, 23 are pulled upwards. The cheek plate 2 is pulled upwards until it comes to stop on the body 20. At the same time, the bush 29 is pulled downwards. In the right-hand dead center position of the eccentric drive 21, the bush 29 is no longer in contact with the spring 25.

2. During the further rotation of the eccentric drive 21 which now follows, the bush 29 moves upwards until it comes to stop on the spring 25 where the movement of the bush 29 is temporarily stopped. Instead, the second cheek plate 2 is now pushed downwards until it arrives at the contact 12 to be crimped. The crimp force now builds up between the second cheek plate 2 and the contact 12. As soon as the crimp force reaches the value of the pre-tensioned force F_{V} of the spring 25, the spring 25 is further compressed.

3. In the left-hand dead center position of the eccentric drive 21, the bush 29 is pushed against the spring 25 and the cheek plate 2 against the contact 12 resting on the first cheek plate 1, whereby the crimp force is equal to the force of the spring 25.

4. During the further rotation of the eccentric drive 21 which now follows, the force exerted by the eccentric drive 21 on the spring 25 and the contact 12 via the knuckle joints 22, 23 is continuously reduced, whereby the second cheek plate 2 is moved upwards until it comes to stop on the body 20.

After that, the bush 29 is pulled downwards thereby releasing itself from the spring 25. With a different embodiment of the knuckle-joint press, the spring 25 is missing. Instead of the spring 25, a height-adjustable body is foreseen on which the bush 29 stops during operation. The bush 29 is formed with a spring joint which builds up a force when the bush 29 is pushed upwards against this body. The position of the body in vertical direction determines the path in which the spring joint deflects during the crimping process and therefore the set crimp force.

FIG. 9 shows a contact processing station with a linear press which has body 31 which is secured against twisting and which is driven in vertical direction by a spindle 30. The second cheek plate 2 is secured to the end of a rod 9a which, by means of a spring 32, is spring-mounted on the body 31. The spring 32 can be tensioned to a predetermined force by means of an adjusting screw 33. The spindle 30 is driven by a motor 34, whereby a gear 35 is connected between the spindle 30 and the motor 34. The stroke which is travelled each time by the second cheek plate 2 and thereby the maximum effective crimp force during the crimping process is adjustable by the number of rotations of the motor 34. Because the spring 32 cushions the impact exerted on the second cheek plate 2 by the contact 12 during the crimping process, the thread of the spindle 30 is only strained insignificantly.

The two cheek plates 1 and 2 are often integrated into a module which is inserted into the press. This enables fast exchange as the cheek plates 1 and 2 are shaped according to the type of cable and the type of contact to be processed. Therefore, it is also possible to foresee an elastically deformable element, for example a spring, within this module in order to produce the spring mounting of the first and/or second cheek plate 1, 2.

It is also possible to produce the spring mounting of the first and/or second cheek plate 1, 2 in that one or more parts are elastically or spring mounted somewhere within the flow of force from the first to the second cheek plate 1 and 2. Therefore, for example with the embodiment described based on FIG. 8, the basic frame 19 itself could be formed as a spring.

Furthermore, during the crimping process, it is possible to detect the trend of deformation of the elastically deformable element by means of a measuring system and to determine the trend of the crimp force from it. This data can be used in the sense of a quality control in order to reject crimped cables as scrap when the trend of the crimp force is outside a predetermined tolerance range.

1. Contact processing station for crimping a contact onto a wire, with a mechanical press comprising a first cheek plate, a second cheek plate, a drive for controlling the second cheek plate and an elastically deformable element for the spring-mounting of the first or second cheek plate, wherein the elastically deformable element is increasingly deformed during the crimping process until a force acting on the contact has reached a maximum and wherein the force acting on the contact builds up continuously with increasing deformation of the elastically deformable element.

2. Contact processing station according to claim 1, wherein the elastically deformable element is a spring.

3. Contact processing station according to claim 1, wherein the elastically deformable element is a connecting rod capable of deformation.

4. Contact processing station according to claim 1, wherein a position of the elastically deformable element is adjustable.

5. Contact processing station according to claim 2, wherein a position of the elastically deformable element is adjustable.

6. Contact processing station according to claim 3, wherein a position of the elastically deformable element is adjustable.

7. Contact processing station according to claim 1, wherein a basic frame of the mechanical press is developed as elastically deformable or spring-mounted element.

8. Contact processing station according to claim 1, wherein the first and second cheek plates are parts of a module which can be inserted into the mechanical press and that the spring mounting of the first cheek plate or the second cheek plate takes place within the module.

9. Contact processing station according to claim 1, wherein a measuring system is provided in order to acquire the trend of deformation and/or the maximum deformation of the elastically deformable element during the crimping process.

10. Contact processing station according to claim 2, wherein a measuring system is provided in order to acquire the trend of deformation and/or the maximum deformation of the elastically deformable element during the crimping process.

11. Contact processing station according to claim 3, wherein a measuring system is provided in order to acquire the trend of deformation and/or the maximum deformation of the elastically deformable element during the crimping process.

12. Contact processing station according to claim 4, wherein a measuring system is provided in order to acquire the trend of deformation and/or the maximum deformation of the elastically deformable element during the crimping process.

13. Contact processing station according to claim 5, wherein a measuring system is provided in order to acquire the trend of deformation and/or the maximum deformation of the elastically deformable element during the crimping process.

14. Contact processing station according to claim 6, wherein a measuring system is provided in order to acquire the trend of deformation and/or the maximum deformation of the elastically deformable element during the crimping process.

15. Contact processing station according to claim 7, wherein a measuring system is provided in order to acquire the trend of deformation and/or the maximum deformation of the elastically deformable element during the crimping process.

16. Contact processing station according to claim 8, wherein a measuring system is provided in order to acquire the trend of deformation and/or the maximum deformation of the elastically deformable element during the crimping process.

17. Contact processing station according to claim 9, wherein a crimped cable is rejected as scrap when the trend of deformation of the elastically deformable element is outside a predetermined tolerance range.

18. Contact processing station according to claim 10, wherein a crimped cable is rejected as scrap when the trend of deformation of the elastically deformable element is outside a predetermined tolerance range.

19. Contact processing station according to claim 11, wherein a crimped cable is rejected as scrap when the trend of deformation of the elastically deformable element is outside a predetermined tolerance range.

20. Contact processing station according to claim 12, wherein a crimped cable is rejected as scrap when the trend of deformation of the elastically deformable element is outside a predetermined tolerance range.
